(19) United States
(12) Patent Application Publication
(10) Pub. No.: US 2026/0011939 A1
(43) Pub. Date: Jan. 8, 2026

(54) Electrical Connection Assembly, Connector And Connector Assembly

(71) Applicant: Tyco Electronics (Shanghai) Co., Ltd., Shanghai (CN)

(72) Inventors: Ke Wang, Suzhou (CN); Xiao (Nichee) Zhou, Shanghai (CN); Wei Yuan, Shanghai (CN)

(73) Assignee: Tyco Electronics (Shanghai) Co., Ltd., Shanghai (CN)

(21) Appl. No.: 19/262,646

(22) Filed: Jul. 8, 2025

(30) Foreign Application Priority Data
Jul. 8, 2024 (CN) 202410913823.7

(51) Int. Cl. H01R 12/58; H01R 13/422

(52) U.S. Cl. CPC H01R 12/585; H01R 13/422

(57) ABSTRACT

An electrical connection assembly includes a circuit board, a first terminal, and a second terminal. The circuit board has a first receptacle, a second receptacle, a front face and a back face. The first terminal extends in a first direction perpendicular to the circuit board and has one end press-fitted into the first receptacle from the front face of the circuit board. The second terminal includes a first extension and a second extension. The first extension extends in the first direction and has one end press-fitted into the second receptacle from the back face of the circuit board. The second extension is connected to an other end of the first extension and extends in a second direction perpendicular to the first direction. The first terminal is electrically connected to the second terminal by a conductive trace on the circuit board.

### CROSS-REFERENCE TO RELATED APPLICATION

This application claims the benefit of Chinese Patent Application No. CN202410913823.7 filed on Jul. 8, 2024, the whole disclosure of which is incorporated herein by reference.

### FIELD OF THE INVENTION

The present invention relates to an electrical connection assembly and, more particularly, to an electrical connection assembly including a connector of the electrical connection assembly, and including a mating connector of the connector.

### BACKGROUND OF THE INVENTION

High-speed data connectors with a right-angle connection (90-degree connection) typically include a housing and a terminal that is bent by 90 degrees. The terminal includes a horizontal extension and a vertical extension. The horizontal extension of the terminal is fixed in the housing for mating with a mating terminal of a mating connector. The vertical extension of the terminal extends downwardly beyond a bottom surface of the housing for soldering to a client circuit board. Such existing terminal has a long length, occupies much space, is easily deformed, and is difficult to manufacture and assemble.

### SUMMARY OF THE INVENTION

An electrical connection assembly includes a circuit board, a first terminal, and a second terminal. The circuit board is formed with a first receptacle and a second receptacle. The circuit board has a front face and a back face opposite each other in a thickness direction of the circuit board. The first terminal extends in a first direction perpendicular to the circuit board and has one end press-fitted into the first receptacle from the front face of the circuit board. The second terminal includes a first extension and a second extension. The first extension extends in the first direction and has one end press-fitted into the second receptacle from the back face of the circuit board. The second extension is connected to an other end of the first extension and extends in a second direction perpendicular to the first direction. The first terminal is electrically connected to the second terminal via a conductive trace formed on the circuit board.

### BRIEF DESCRIPTION OF DRAWINGS

The invention will now be described by way of example with reference to the accompanying figures, of which:

FIG. 1 is a perspective view of an electrical connection assembly according to an exemplary embodiment;

FIG. 2 is an exploded view of the electrical connection assembly of FIG. 1;

FIG. 3 is an exploded view of a connector according to an exemplary embodiment, in which the electrical connection assembly of FIG. 1 has not yet been assembled to a housing of the connector;

FIG. 4 shows is a perspective view of the connector of FIG. 3, in which the electrical connection assembly of FIG. 1 has been assembled to the housing of FIG. 3;

FIG. 5 is a perspective view of the connector of FIG. 3, in which a terminal holding plate has not yet been assembled to the housing of FIG. 3; and

FIG. 6 is a perspective view of the connector of FIG. 3, in which the terminal holding plate of FIG. 5 has been assembled to the housing of FIG. 3.

### DETAILED DESCRIPTION

Exemplary embodiments of the present disclosure will be described hereinafter in detail with reference to the attached drawings, where like reference numerals refer to the like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

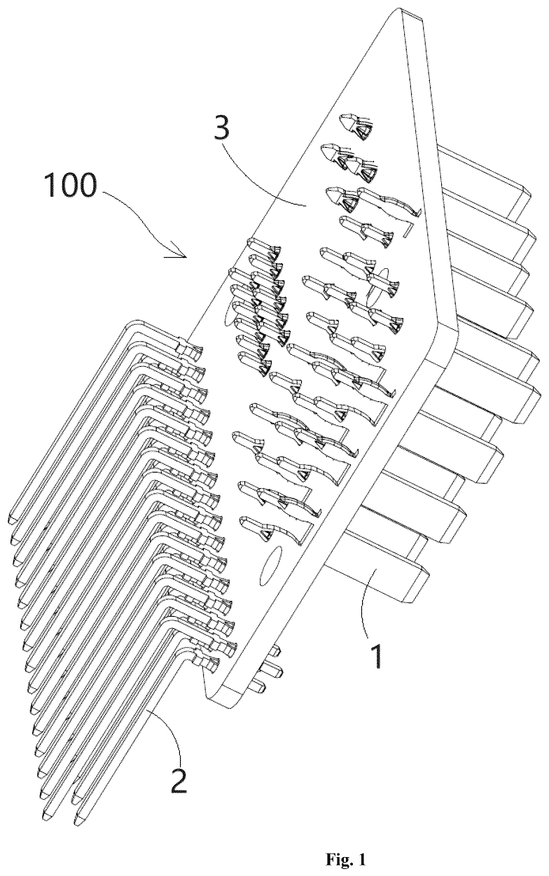

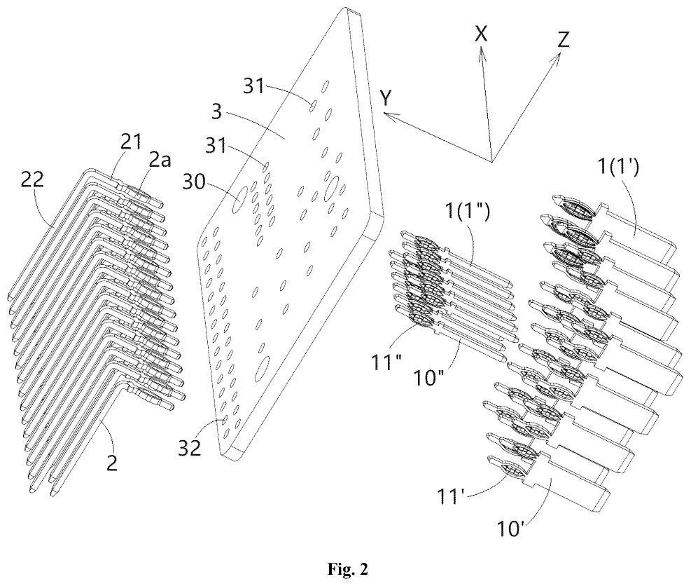

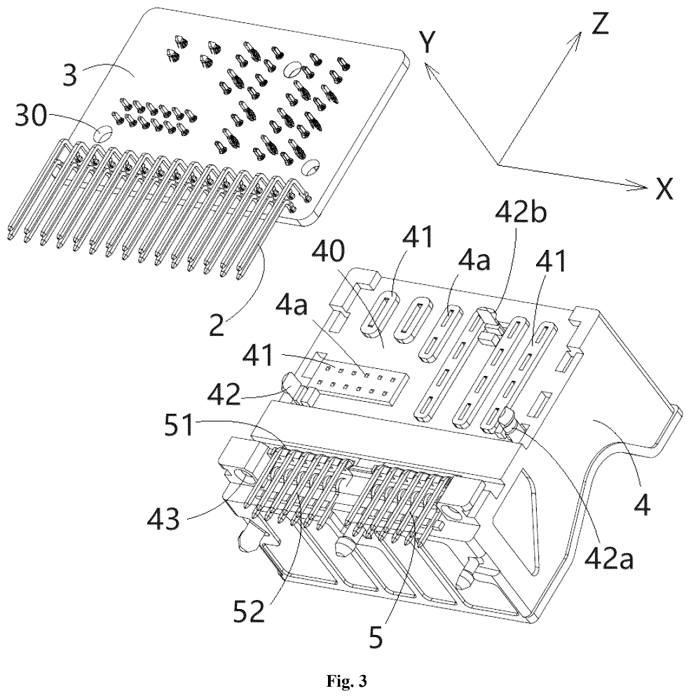

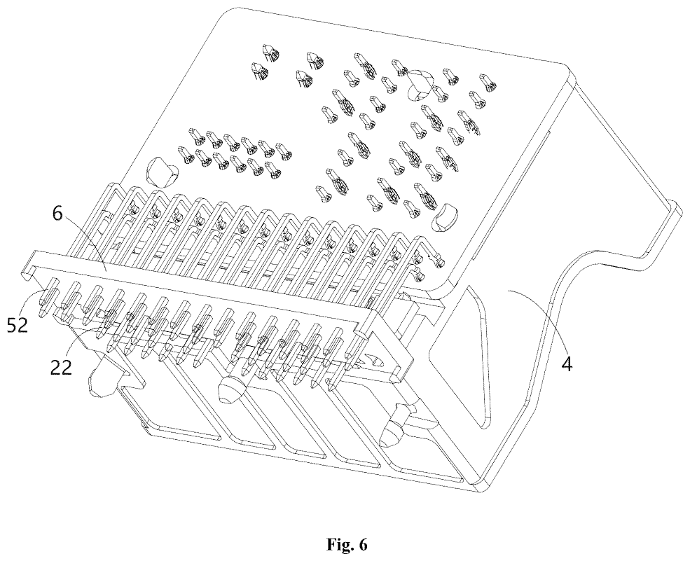

An exemplary embodiment of an electric connection assembly will now be described with reference to FIGS. 1-6. As shown in FIGS. 1-2, the electrical connection assembly 100 includes a circuit board 3, a first terminal 1, and a second terminal 2. The circuit board 3, as shown in FIG. 2, is formed with a first receptacle 31 and a second receptacle 32 and has a front face and a back face opposite in a thickness direction thereof. The first terminal 1 extends in a first direction Y perpendicular to the circuit board 3 and, as shown in FIG. 1, has one end press-fitted into the first receptacle 31 from the front face of the circuit board 3. As shown in FIG. 3, the second terminal 2 includes a first extension 21 and a second extension 22. The first extension 21 extends in the first direction Y and has one end press-fitted into the second receptacle 32 from the back face of the circuit board 3. The second extension 22 is connected to the other end of the first extension 21 and extends in a second direction Z perpendicular to the first direction Y. The first terminal 1 is electrically connected to the second terminal 2 via a conductive trace formed on the circuit board 3.

As shown in FIG. 1, the electrical connection assembly 100 includes a plurality of first terminals 1 and a plurality of second terminals 2. The plurality of first terminals 1 are electrically connected to the plurality of second terminals 2, respectively, via conductive traces on the circuit board 3.

As shown in FIG. 2, the plurality of first terminals 1 include a plurality of first power supply terminals 1′ for transmitting a current, and a plurality of first signal terminals 1″ for transmitting a signal. A shape and a size of the first power supply terminals 1′ are different than a shape and a size of the first signal terminals 1″.

As shown in FIG. 2, the first power supply terminal 1′ includes a plate-like body 10′ adapted to mate with a mating power supply terminal, and a pair of first power supply terminal pins 11′ connected to one end of the plate-like body 10′. The pair of first power supply terminal pins 11′ are press-fitted into a corresponding pair of first receptacles 31 in the circuit board 3. In the illustrated embodiment, as shown in FIG. 2, the first power supply terminal pin 11′ is fisheye-shaped.

As shown in FIG. 2, the first signal terminal 1″ includes a needle-like body 10″ adapted to mate with a mating signal terminal, and a first signal terminal pin 11″ connected to one end of the needle-like body 10″. The first signal terminal pin 11″ is press-fitted into a corresponding first receptacle 31 in the circuit board 3. In the illustrated embodiment, as shown in FIG. 2, the first signal terminal pin 11″ is fisheye-shaped.

The plurality of second terminals 2 include a plurality of second power supply terminals respectively corresponding to the plurality of first power supply terminals 1′ and a plurality of second signal terminals respectively corresponding to the plurality of first signal terminals 1″. The second power supply terminals and the second signal terminals are identical to each other.

As shown in FIG. 2, the second pin 2a is formed at one end of the first extension 21 of the second terminal 2. The second pin 2a is press-fitted into the second receptacle 32 in the circuit board 3. The second extension 22 of the second terminal 2 is needle-shaped and extends by a predetermined length in the second direction Z for electrical connection to a circuit board, such as a client circuit board. In the illustrated embodiment, as shown in FIG. 2, the second pin 2a is fisheye-shaped.

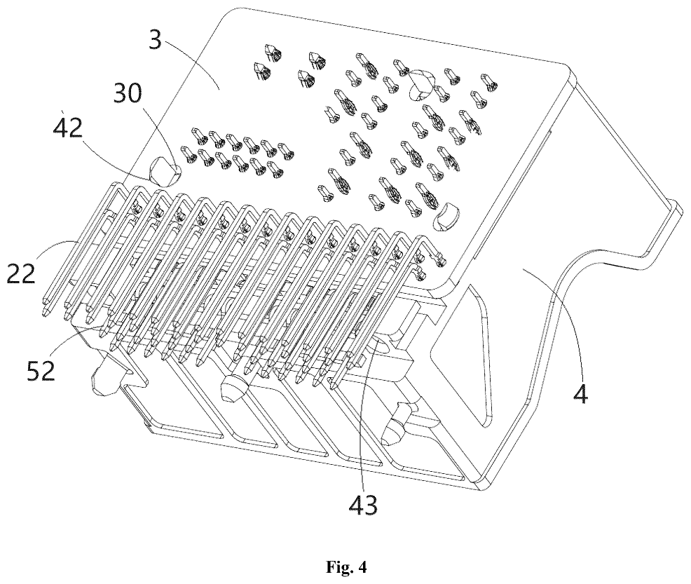

As shown in FIGS. 2-4, a plurality of engagement holes 30 are formed in the circuit board 3. As shown in FIG. 4, the plurality of engagement holes 30 are adapted to engage with a plurality of elastic latches 42 on a housing 4 of a connector to fix the electrical connection assembly 100 to the housing 4. In the illustrated embodiment, as shown in FIGS. 2-4, three engagement holes 30 are formed in the circuit board 3. Lines connecting centers of the three engagement holes 30 form a triangle. In other words, a plurality of lines connecting a center of each engagement hole form a triangle.

An exemplary embodiment of a connector will now be described with reference to FIGS. 1-6. The connector includes a housing 4, shown in FIGS. 3-6, and the electrical connection assembly 100 as described above.

As shown in FIG. 3, the housing 4 has a front opening and a rear side wall 40 opposite in a first direction (i.e., a longitudinal direction of the housing 4) Y, and a top wall and a bottom wall opposite in a second direction (i.e., a height direction of the housing 4) Z. The circuit board 3 of the electrical connection assembly 100 is fixed to an outer side of the rear side wall 40 of the housing 4. A slot hole 4a, as shown in FIG. 3, corresponding to the first terminal 1 is formed in the rear side wall 40 of the housing 4, and a first terminal 1 of the electrical connection assembly 100 is inserted into the housing 4 through the slot hole 4a, to mate with a mating terminal of a mating connector inserted into the housing 4.

As shown in FIG. 2, a plurality of support protrusions 41 are formed on the outer side of the rear side wall 40 of the housing 4. The plurality of support protrusions 41 each have a flat support surface. The support surfaces of each of the plurality of support protrusions 41 lie in the same plane. The circuit board 3 is supported on the support surfaces of the plurality of support protrusions 41.

As shown in FIG. 2, the slot hole 4a is formed in the support protrusion 41. The support protrusion 41 is strip-shaped and extends in the second direction Z and/or a third direction X. The third direction X is perpendicular to the first direction Y and the second direction Z.

As shown in FIG. 2, a plurality of elastic latches 42 are formed on the outer side of the rear side wall 40 of the housing 4. As shown in FIGS. 2-3, each elastic latch 42 of the plurality of clastic latches 42 is respectively engaged into one of a plurality of engagement holes 30 in the circuit board 3, to fix the circuit board 3 to the rear side wall 40 of the housing 4. Each elastic latch 42 includes an elastic arm 42a and a raised part 42b formed at a tail end of the clastic arm 42a. The clastic arm 42a is inserted into the engagement hole 30 from a front face of the circuit board 3, and the raised part 42b abuts against an edge portion of an opening of the engagement hole 30 that is located at a back face of the circuit board 3.

As shown in FIGS. 4-6, the second extension 22 of the second terminal 2 extends in the second direction Z beyond the bottom wall of the housing 4 for electrical connection to a circuit board, such as the client circuit board.

As shown in FIG. 3, the connector further includes a third terminal 5. The third terminal 5 includes a horizontal extension 51 and a vertical extension 52. The horizontal extension 51 of the third terminal 5 extends in the first direction Y and runs into the housing 4 from the rear side wall 40 of the housing 4. The vertical extension 52 of the third terminal 5 is located outside the housing 4 and extends in the second direction Z beyond the bottom wall of the housing 4 for electrical connection to the client circuit board.

As shown in FIG. 3, the connector includes a plurality of third terminals 5. The horizontal extensions 51 of the plurality of third terminals 5 are located below the first extensions 21 of the plurality of second terminals 2, and the vertical extensions 52 of the plurality of third terminals 5 are closer to the rear side wall 40 of the housing 4 than the second extensions 22 of the plurality of second terminals 2.

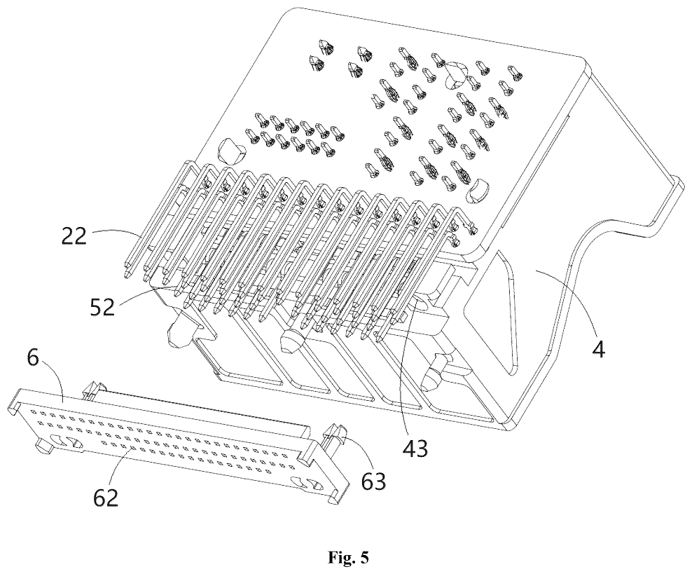

As shown in FIG. 5, the connector further includes a terminal holding plate 6 mounted to a bottom of the housing 4 for holding the second extension 22 of the second terminal 2 and the vertical extension 52 of the third terminal 5. The terminal holding plate 6 is formed with a plurality of positioning holes 62 allowing the second extension 22 of the second terminal 2 and the vertical extension 52 of the third terminal 5 to pass through, respectively.

A plurality of elastic latches 63, as shown in FIG. 5, are formed on the terminal holding plate 6, and a plurality of locking holes 43, as shown in FIGS. 3-5, are formed in the bottom of the housing 4. The plurality of elastic latches 63 are respectively engaged into the plurality of locking holes 43, to fix the terminal holding plate 6 to the bottom of the housing 4.

An exemplary embodiment of a connection assembly will now be described with reference to FIGS. 1-6. The connection assembly includes the connector as described above and a mating connector. The mating connector is inserted into the front opening of the housing 4 of the connector. A mating terminal of the mating connector mates with the first terminal 1 and the third terminal 5 of the connector.

In the aforementioned various exemplary embodiments according to the present invention, a length of the first terminal 1 and a length of the second terminal 2 are relatively short, making it easy to press-fit the first terminal 1 and the second terminal 2 into receptacles of the circuit board 3, reducing assembly difficulty, assembly time, and cost. In addition, the present invention can greatly reduce a volume of the product by connecting the first terminal 1 and the second terminal 2 through the circuit board 3.

It should be appreciated by those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “including” or “having” an element or a plurality of elements having a particular property may include additional such elements not having that property.

1. An electrical connection assembly, comprising:
a circuit board formed with a first receptacle and a second receptacle, the circuit board has a front face and a back face opposite each other in a thickness direction of the circuit board;
a first terminal extending in a first direction perpendicular to the circuit board and having one end press-fitted into the first receptacle from the front face of the circuit board; and
a second terminal including a first extension and a second extension, the first extension extends in the first direction and has one end press-fitted into the second receptacle from the back face of the circuit board, the second extension is connected to an other end of the first extension and extends in a second direction perpendicular to the first direction, the first terminal is electrically connected to the second terminal via a conductive trace formed on the circuit board.

2. The electrical connection assembly of claim 1, wherein the electrical connection assembly has a plurality of first terminals and a plurality of second terminals, each first terminal is electrically connected to one second terminal via conductive traces on the circuit board.

3. The electrical connection assembly of claim 2, wherein the plurality of first terminals include a plurality of first power supply terminals transmitting a current and a plurality of first signal terminals transmitting a signal, a shape and a size of each first power supply terminal is different than a shape and a size of each first signal terminal.

4. The electrical connection assembly of claim 3, wherein each first power supply terminal has a plate-like body and a pair of first power supply terminal pins connected to one end of the plate-like body, the plate-like body mates with a mating power supply terminal, the pair of first power supply terminal pins are press-fitted into a corresponding pair of first receptacles in the circuit board.

5. The electrical connection assembly of claim 3, wherein each first signal terminal has a needle-like body and a first signal terminal pin connected to one end of the needle-like body, the needle-like body mates with a mating signal terminal, the first signal terminal pin is press-fitted into a corresponding first receptacle in the circuit board.

6. The electrical connection assembly of claim 3, wherein the plurality of second terminals include a plurality of second power supply terminals each corresponding to one first power supply terminal, and a plurality of second signal terminals each corresponding to one first signal terminal, each second power supply terminal is identical to each second signal terminal.

7. The electrical connection assembly of claim 6, wherein a second pin is formed at one end of the first extension of the second terminal, the second pin is press-fitted into the second receptacle in the circuit board, and the second extension of the second terminal is needle-shaped and extends by a predetermined length in the second direction for electrical connection to a client circuit board.

8. The electrical connection assembly of claim 1, wherein a plurality of engagement holes are formed in the circuit board, each engagement hole engages with one of a plurality of elastic latches on a housing of a connector to fix the electrical connection assembly to the housing.

9. The electrical connection assembly of claim 8, wherein three engagement holes are formed in the circuit board, and a plurality of lines connecting a center of each engagement hole form a triangle.

10. A connector, comprising:
a housing having a front opening and a rear side wall opposite each other in a first direction, and a top wall and a bottom wall opposite each other in a second direction; and
an electrical connection assembly including a circuit board, a first terminal, and a second terminal, the circuit board is formed with a first receptacle and a second receptacle, the circuit board has a front face and a back face opposite each other in a thickness direction of the circuit board, the first terminal extends in the first direction perpendicular to the circuit board and has one end press-fitted into the first receptacle from the front face of the circuit board, and the second terminal includes a first extension and a second extension, the first extension extends in the first direction and has one end press-fitted into the second receptacle from the back face of the circuit board, the second extension is connected to an other end of the first extension and extends in the second direction perpendicular to the first direction, the first terminal is electrically connected to the second terminal via a conductive trace formed on the circuit board, the circuit board of the electrical connection assembly is fixed to an outer side of the rear side wall of the housing, a slot hole corresponding to the first terminal is formed in the rear side wall of the housing, the first terminal is inserted into the housing through the slot hole to mate with a mating terminal of a mating connector inserted into the housing.

11. The connector of claim 10, wherein a plurality of support protrusions are formed on the outer side of the rear side wall of the housing, the plurality of support protrusions each have a flat support surface, each support surface lies in the same plane, the circuit board is supported on each support surface.

12. The connector of claim 11, wherein a plurality of slot holes are formed in the rear side wall of the housing, each slot hole is formed in one support protrusion, each support protrusion is strip-shaped and extends in the second direction and/or a third direction, the third direction being perpendicular to the first direction and the second direction.

13. The connector of claim 10, wherein a plurality of elastic latches are formed on the outer side of the rear side wall of the housing, each elastic latch is engaged into one engagement hole to fix the circuit board to the rear side wall of the housing.

14. The connector of claim 13, wherein each elastic latch has an elastic arm and a raised part formed at a tail end of the elastic arm, each elastic arm is inserted into one engagement hole from the front face of the circuit board, and the raised part abuts against an edge portion of an opening of the one engagement hole that is located at the back face of the circuit board.

15. The connector of claim 10, wherein the second extension of the second terminal extends in the second direction beyond the bottom wall of the housing for electrical connection to a client circuit board.

16. The connector of claim 15, further comprising a third terminal including a horizontal extension and a vertical extension, the horizontal extension extends in the first direction and runs into the housing from the rear side wall of the housing, and the vertical extension is located outside the housing and extends in the second direction beyond the bottom wall of the housing for electrical connection to the client circuit board.

17. The connector of claim 16, wherein the connector has a plurality of third terminals, each horizontal extension of each third terminal is located below each first extension of each second terminal, and each vertical extension of each third terminal is closer to the rear side wall of the housing than each second extension of each second terminal.

18. The connector of claim 17, further comprising a terminal holding plate mounted to a bottom of the housing, the terminal holding plate holds each second extension of each second terminal and each vertical extension of each third terminal, the terminal holding plate is formed with a plurality of positioning holes, each positioning hole allows one second extension or one vertical extension to pass through.

19. The connector of claim 18, wherein a plurality of elastic latches are formed on the terminal holding plate, and a plurality of locking holes are formed in the bottom of the housing, each elastic latch engages into one locking hole to fix the terminal holding plate to the bottom of the housing.

20. A connector assembly, comprising:
a connector including a housing and an electrical connection assembly, the housing has a front opening and a rear side wall opposite each other in a first direction, and a top wall and a bottom wall opposite each other in a second direction, and the electrical connection assembly includes a circuit board, a first terminal, and a second terminal, the circuit board is formed with a first receptacle and a second receptacle, the circuit board has a front face and a back face opposite each other in a thickness direction of the circuit board, the first terminal extends in the first direction perpendicular to the circuit board and has one end press-fitted into the first receptacle from the front face of the circuit board, and the second terminal includes a first extension and a second extension, the first extension extends in the first direction and has one end press-fitted into the second receptacle from the back face of the circuit board, the second extension is connected to an other end of the first extension and extends in the second direction perpendicular to the first direction, the first terminal is electrically connected to the second terminal via a conductive trace formed on the circuit board, the circuit board of the electrical connection assembly is fixed to an outer side of the rear side wall of the housing, a slot hole corresponding to the first terminal is formed in the rear side wall of the housing; and
a mating connector inserted into the front opening of the housing of the connector, the first terminal is inserted into the housing through the slot hole to mate with a mating terminal of the mating connector inserted into the housing.
